(19) United States
(12) Patent Application Publication
(10) Pub. No.: US 2009/0055725 A1
(43) Pub. Date: Feb. 26, 2009

(54) System and Method for Generating Creatives Using Composite Templates

(75) Inventors: Dmitriy Portnov, San Jose, CA (US); Manish Gupta, Santa Clara, CA (US); Sarah Sirajuddin, Sunnyvale, CA (US); Chao Cai, Mountain View, CA (US); Kenji Kaneda, Tokyo (JP); Rajas Moonka, San Ramon, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/844,076

(22) Filed: Aug. 23, 2007

(51) Int. Cl. G06F 17/00

(52) U.S. Cl. 715/234

(57) ABSTRACT

A computer-implemented method for generating creatives includes creating a first composite template. The method also includes defining one or more template elements for use with the first composite template. The method further includes assigning data to each of the one or more template elements. The method also includes generating a first creative based on the first composite template and the assigned data. The first creative comprises one or more creative elements corresponding to the one or more template elements.

### TECHNICAL FIELD

This subject matter generally relates to advertising systems, and more particularly to systems and methods for generating creatives using composite templates.

### BACKGROUND

Businesses and other entities increasingly use the Internet to increase awareness of their products and services. Often a business will place advertisements on web pages that are not hosted by the business in order to reach a wider audience. An advertisement may include a “creative,” which may include any combination of text, graphics, audio, and video components, to communicate information about the business, its products, or its services. Creatives may be distributed through a variety of media, such as radio, television, magazines, and the Internet. The number and variety of creatives published on the Internet continues to increase. Search engines, such as Google Web Search, may advertise various services and products when providing search results to a user. Other publishers of web content may also advertise various services and products that are not provided by the publishers themselves. Often, a creative is displayed in a delimited area of a web page, but may also be placed in its own web page or browser window that is displayed, for example, when a user navigates from one web page to another or after a certain amount of time has transpired after serving a particular web page. Generating creatives can be a daunting task, especially for novice advertisers.

### SUMMARY

In one embodiment, a method for generating creatives includes creating a first composite template. The method also includes defining one or more template elements for use with the first composite template. The method further includes assigning data to each of the one or more template elements. The method also includes generating a first creative based on the first composite template and the assigned data. The first creative comprises one or more creative elements corresponding to the one or more template elements.

In another embodiment, a method for serving creatives includes receiving a request for a creative. The request includes an ad slot identifier. The method also includes identifying one or more creatives using the ad slot identifier. The method further includes determining a particular creative of the one or more creatives to return. The method also includes returning the particular creative in response to the request.

The method may further include creating an ad slot; associating the ad slot with the first composite template; and targeting the generated first creative to the ad slot. The method may also include creating a second composite template; defining at least one template element for the second composite template; assigning data to each of the at least one template element; generating a second creative based on the second composite template and the assigned data of the at least one template element; associating the ad slot with the second composite template; and targeting the created second creative to the ad slot. Associating the ad slot with the first composite template may include defining one or more attributes of the first composite template; and associating the ad slot with the one or more attributes.

Assigning data may include generating a form, wherein the form comprises fields corresponding to the one or more template elements; presenting the form; receiving input for each field, wherein the input comprises data corresponding to each of the one or more template elements; and assigning data to each of the one or more template elements. The method may also include storing the first composite template and/or storing the generated first creative. Each template element may include a video, a text element, or an image.

The method may further include associating an interaction metric with a first of the one or more creative elements; tracking events associated with the first creative element; and updating the interaction metric based on the tracked events. The method may also further include associating the interaction metric with a second of the one or more creative elements; tracking events associated with the second creative element; and updating the interaction metric based on the tracked events associated with the first creative element and the tracked events associated with the second creative element.

Each of the foregoing—as well as other disclosed—example methods may be computer implementable. Moreover some or all of these aspects may be further included in respective systems and software for creating composite templates and/or generating creatives. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a creative generator system.

FIG. 1B is an illustration of example templates.

FIG. 2 is an example system in which the subject matter disclosed herein may be implemented.

FIG. 3 is an example process for defining composite templates.

FIG. 4 is an example process for generating creatives from composite templates.

FIG. 5 is an example process for serving creatives.

### DETAILED DESCRIPTION

In general, the disclosed subject matter uses composite templates to generate creatives. Creatives may include, among other content, video, image, text, and/or Adobe Flash™ content. Each creative may contain one or more elements that include element fields. The element fields are the basic building blocks for a creative and contain the data for the actual content of the creative. For example, element fields for a text element may store data related to each line of text, e.g., Line1, Line2, and Line3, of the creative, a universal resource locator (URL) associated with the advertiser that is displayed, and/or a URL that indicates the web page loaded when the creative is “clicked” by a user. Another example may be an element using Adobe Flash™ (“Flash”) content, which may be hosted by some third party. In that case, a URL that is used to redirect a publisher's webpage to load the Flash content may be stored for the element. Yet another example may be a video hosted on YouTube, for which its video identification and its click URL are stored. The element fields may also include constraints on an element, such as the element's dimensions or duration.

For each element one or more statistics or metrics based on interaction events may be tracked. Interaction events generally occur when a user performs some action that indicates that a creative is being impressed on the user. For example, an interstitial video element (an ad that may appear in the middle of a video stream like a television commercial) may have an interaction event associated with the playing of the video through its midpoint. The system may track the number of users that watched the video through its midpoint or through to the end. If there are multiple interstitial videos within the same template, the publisher may track statistics for each video, as well as aggregated statistics across all videos.

Also for video elements, the system may track a video's start, stop, skip, and pause events. A Flash video game may track the time spent playing the game. Some trackable events may not be tracked in certain contexts, such as a video start event when the video is a pre-roll video (starts without user prompting).

A composite template is an arrangement or structure of elements from which creatives may be generated. An element that is associated with a composite template may be identified as a template element. The association may have a unique identification. Each composite template may be composed of one or more template elements. A given element may be used with multiple composite templates. Each template element may be associated with a set of interaction events that may be tracked for the template element. Associating statistics with template elements may allow aggregation of template element statistics across creatives of different templates. In that way, the relative effectiveness of template elements in comparison to each other may be determined.

A template element may have one or more element fields, which may contain data that provides the content for the template element. When data is assigned to the fields of template elements in a composite template, an instance of a creative may be generated from the composite template. The fields may differ among template elements. An in-stream video template element, for example, may include a video identification field, which may uniquely identify a video in stored in a particular repository. A click-to-play video template element may contain two fields, such as a starter image identification key, which may uniquely identify an image, and a video identification. A text template element may contain four element fields, such as line1, line2, line3, which each define the actual text displayed in each line of text, and text color. Some fields for each template element may be optional, such as, for example, line3 and text color in the example text template element. Fields may also include uniform resource identifiers (“URIs”) or uniform resource locators (“URLs”) that may be used to redirect the system to the data that is associated with the template element field.

Both composite templates and template elements may have controlled access. Some templates and elements may be accessible by a single publisher or a single advertiser. For example, a major automobile manufacturer may define a composite template for local dealers, who may then access and customize the template with their video clips, pictures, and contact information. Other templates and elements may have shared accessibility, which allows multiple or all publishers to access them.

Publishers may also associate composite templates with particular ad slots. Ad slots may be areas reserved for advertisement creatives on a publisher's web page. They may also be of a particular type of creative format, such as one that overlays the entire web page or a portion of it. An ad slot may have dimensions that change depending on a user's interaction with the creative of the ad slot. A publisher may control the types of creatives displayed on its web page by associating ad slots with composite templates that meet its aesthetic and other requirements.

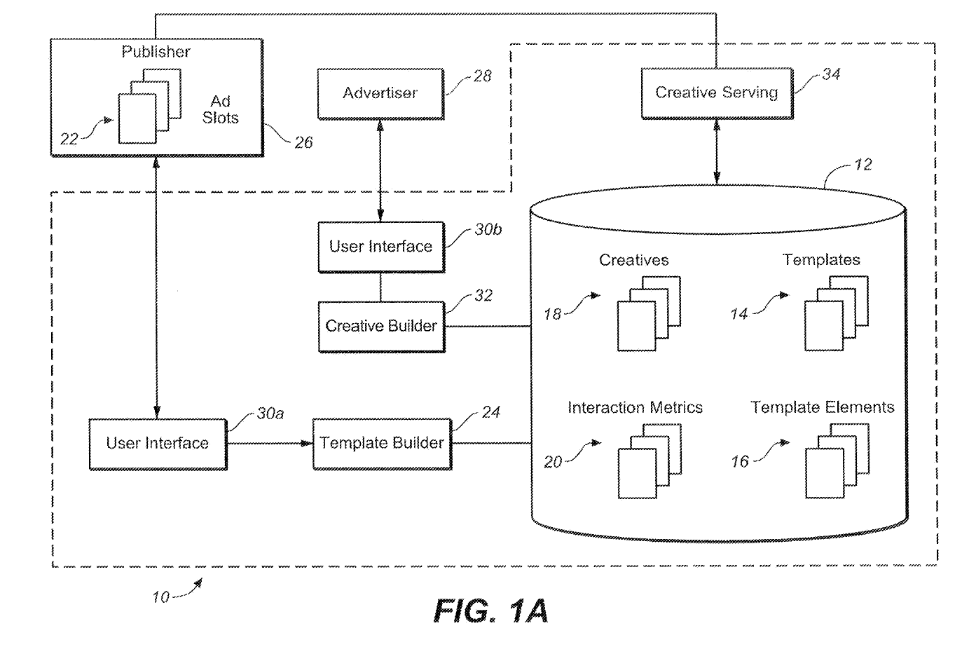

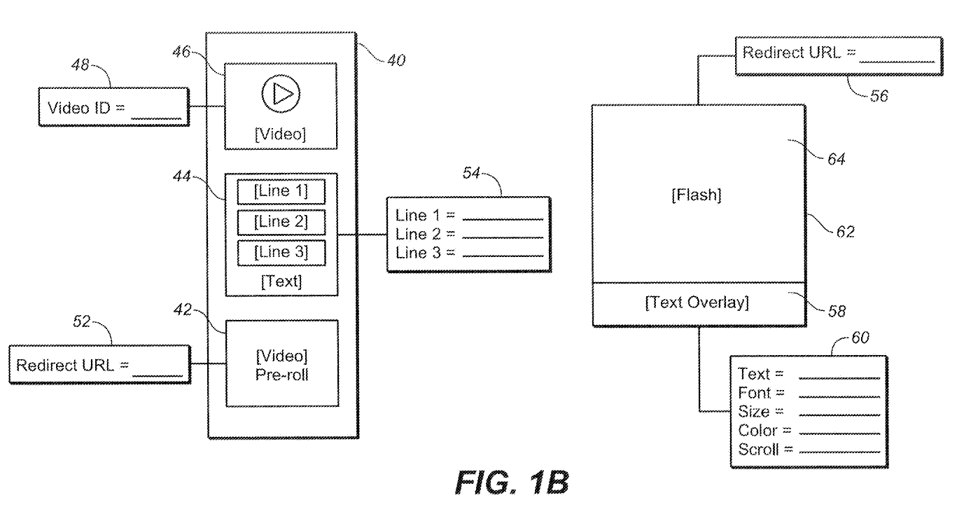

FIG. 1A is a block diagram of a creative generator system. FIG. 1B is an illustration of example templates. System 10 includes, among other things, data store 12, a template builder 24, a creative builder 32, and a creative server 34. Using the template builder 24 and a user interface 30, a publisher 26 may generate a composite template 14, which may include any combination of template elements 16. Creatives 18 generated from certain templates 14 may be targeted to particular ad slots 22 that are associated with the certain templates 14. This targeting may be automated using an auction based system, such as Google AdWords, where the targeting may be determined using advertiser specified criteria such as a list of websites or keywords, and/or using bids or expected revenue to compare and select from creatives that may be served in the ad slot 22.

A publisher 26 may create a composite template 14 to be targeted to an ad slot 22. The template builder 24 may prompt the publisher 26 for the template elements 16 that will be included in the template 14. The size, duration, and other constraints for the templates may be specified for each template element 16 that is included in template 14. The template builder 32 may also prompt the publisher 26 to identify the interaction event data 20 to be tracked. After the publisher 26 has specified the template elements 16 for a template 14 and the interaction event data 20, the template builder 24 may create and store the template 14 in data store 12. User interface 30a may be used to display information to and receive information from the publisher 26. Referring to FIG. 1B, a user may create a composite template 40. Template 40 includes a pre-roll video element 42, a text element 44, and a post-roll video template element 46. A user may also create a composite template 62, which includes Flash element 64 and a text overlay 58.

An advertiser or creative agency 28 may generate creatives 18 using templates 14. The creative builder 32 may prompt the advertiser 28 for a template 14 from which to build the creative 18. After identifying a template 14 from which to build the creative 18, the creative builder 32 may identify each template element 16 associated with the template 14. Using template elements 16, the creative builder 32 may to guide the advertiser 28 through the process of specifying the data related to the fields of each template element 16. User interface 30b may be used to display information to and receive information from the advertiser 28.

User interface 30 may be a custom generated form created by reading a template 14 and generating the appropriate fields in the form for input. For creative content that is hosted by a third party, the fields associated with the template elements may minimally include one field per template element, which may be a redirect URL, a video identification, or some other indicator of the content's location. For creative content that is hosted by the system 10, more input fields may be used. For example, templates 14 that include images hosted in system 10 may need fields generated for the name, title, location within the system, etc. The form may prompt the user for a local file name and automatically upload the file into the system 10, o may prompt the user to select a file from previously uploaded files hosted on the system 10. Referring to FIG. 1B, a user may specify video identification 48 or redirect URL 52. In text field 54, a user may specify data for Line 1 and Line 2, but not for Line 3 which may be optional.

After the advertiser 28 has specified the data related to each of the template elements 16 for the template 14, the creative builder 32 may generate and store a creative 18 in data store 12. The newly generated creative 18 may then be served to a publisher requesting a creative 18 to be used in a particular ad slot 22. The served creative 18 may be selected using an auction based system.

A publisher 26 may request a creative 18 for an ad slot 22 using creative server 34. One or more templates 14 may be compatible with the ad slot 22. Compatibility may be determined from information stored in data store 12 that relates one or more templates 14 to each ad slot 22. The ad slot 22 may also be related to a set of attributes, such as a certain dimensions. A creative 18 that conforms to the set of attributes may be deemed compatible with the ad slot 22. If there are multiple creatives 18 that are compatible, then the creative serving software 34 may utilize one or more algorithms to select the appropriate creative 18 to serve in the ad slot 22. Once served to the web page of the publisher 26, the creative 18 may generate interaction event data 20 based on a user's interaction with the creative 18.

Various metrics may be calculated using the interaction event data 20. For example, a creative that has two elements, a pre-roll video and a post-roll video, may have various metrics that may be calculated. Both of the elements have a video raw element field type, and thus have the same set of trackable statistics and interaction events. However, they might have different sets of meaningful statistics. For example, the pre-roll video might play automatically, thus tracking a video start event may not be desirable. Whereas, with the post-roll video that only plays based on a user's interaction with the element, tracking the video start event may be desirable. The playback length for each element may be tracked, and may be aggregated to determine the total video exposure to a user.

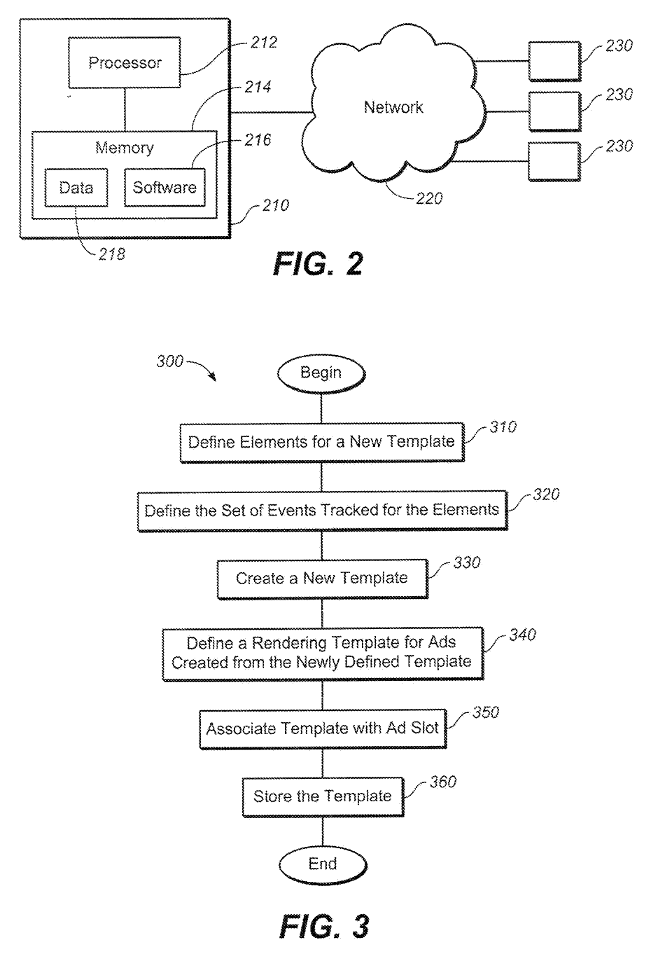

FIG. 2 is an example system in which the subject matter disclosed herein may be implemented. The system includes a server device 210, a network 220, and multiple client devices 230. The server device 210 may include a processor 212 coupled to a computer readable memory 214, such as a random access memory (RAM) or other data store. The server device 210 may also include another data store 218, such as a database, which may be included in memory 214 or communicatively coupled with the server device 210. The server device 210 may include program instructions 216 executable by the processor 212 to implement the template builder 24, the creative builder 32, the creative server 34, and the user interfaces 30. Templates 14, template elements 16, creatives 18, and interaction event data 20 may be stored in memory 214 and data store 218. Although depicted as a single computer system, the server device 210 may be implemented as a network of computers.

The server device 210 communicates with the client devices 230 via the network 220. The network 220 may be a local area network (LAN) or a wide area network (WAN), such as the Internet. Each client device 230 may be associated with a publisher 26 or an advertiser 28, and may comprise a device capable of communicating over the network 210, such as a computer, a mobile communication device, or other communication device. A publisher 26 or an advertiser 28 may provide responses and view displays via a client 230.

FIG. 3 is an example process for defining composite templates. At step 310, the elements for a new template are defined and selected. A user may add new element types by defining the fields that belong to the element. A user may also select from a list of elements that the user previously created, or from globally defined element types. Multiple elements having the same raw element field type may be used together in a single template. These elements may be defined by an administrator of the system or by a user.

At step 320, a set of interaction events may be defined to facilitate tracking statistics for the elements in the new template. The interaction events may be pre-defined and unalterable, or they may be configurable. A user may create custom interaction events, or may select events from a list of possible events that are trackable for a given element.

At step 330, the new template is created and defined using the defined elements and set of interaction events. At step 340, a rendering template may be defined. A rendering template may be an extensible markup language (XML) or custom hyper-text markup language (custom HTML), or some other file that describes the way the elements should be rendered in a web page. The file, for example may contain HTML code with place holders that are determined from the actual creative that is generated from the template. The system may or a user may define the rendering template.

At step 350, the newly created template may be associated with an ad slot. The template may be associated with multiple ad slots. An ad slot may also have defined criteria that each targeted creative must satisfy. The criteria may be based on a set of attributes that each creative must have in common, such as certain dimensions, placement, or duration. The system may store the attributes of the template for use in later determinations of whether a creative generated from the template is usable in a given ad slot, such as selecting a creative using an auction based system. At step 360, the template and its related data are stored.

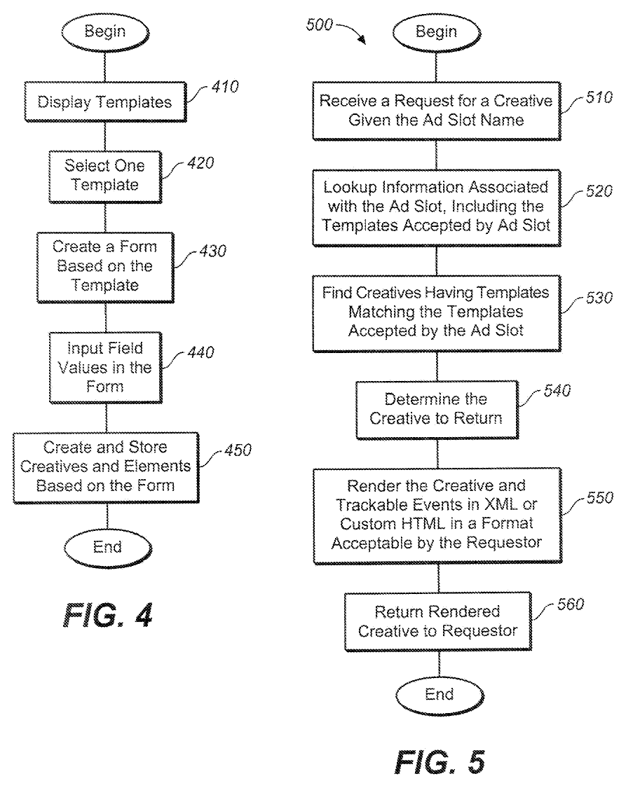

FIG. 4 is an example process 400 for generating creatives from composite templates. At step 410, the available templates may be displayed. A user may have previously logged into the system and chose an option to create a new ad. The templates available may depend on which templates a user has been granted access to view. This may include a list of templates the user previously created and a list of globally defined templates. An example of a globally defined template may be a template named “Pre-roll only,” which defines a creative with only one element—a pre-roll video. This template may also contain the set of interaction events to be tracked for that pre-roll video.

At step 420, a user may select a template to use in the creative generation. At step 430, a form may be generated based on the elements in the template. Each element may have pre-defined fields that allow customization of the elements. A field, for example, may be text color to allow a user to specify the color of text rendered in a particular text element in the template. For content that is hosted by a third party, the field for a template may be a URL that allows locating the actual creative content to be displayed in the element. At step 440, the user may specify the data for each field in the generated form.

At step 450, the creative is generated based on the input from the form and stored to be served later. The generation of the creative may also use a rendering template if one is available. The images and other content may be incorporated into the creative at this point and the creative may be stored in a serialized format to facilitate its serving.

FIG. 5 is an example process 500 for serving creatives. At step 510, a request to provide a creative for a particular ad slot may be received. At step 520, information associated with the particular ad slot may be retrieved. This information may include a list of templates that are compatible the particular ad slot. The list of compatible templates may be directly associated with the ad slot or it may be determined using targeting attributes. The targeting attributes may be loaded for each creative that is based on a given template. The ad slot may be associated with the targeting attributes. This allows new templates and creatives to be retrievable for a given set of ad slots without the additional step of associating each new creative directly with each ad slot with which it is compatible. The targeting attributes may be widely varied from the abstract, such as an identification of a grouping, to the concrete, such as ad height and width or ad duration. One goal may be to match structurally compatible ad slots and templates.

At step 530, a list of creatives generated from templates that are compatible with the particular ad slot may be retrieved. At step 540, a particular creative may be selected from the list of compatible creatives. The particular creative may be selected using an auction based process.

At step 550, the selected creative and its related interaction events may be rendered in XML, JavaScript Object Notation (JSON), key value pairs, custom HTML, or any other format that may be interpreted directly or indirectly by the requesting entity. The related interaction events may be rendered using URLs for each event. The URLs that report interactions may include a label indicating the type of interaction, and a template element identification parameter to be passed through into the tracking database. Providing the element associated with the interaction event may allow flexibility in aggregating the statistics. At step 560, the creative may be returned to the requesting entity. After being displayed on a web page, the creative viewed and interacted with by a user. The user's interactions may be tracked using interaction metrics.

A number of embodiments have been described. Nevertheless, it will be understood that various modifications may be made without departing from the spirit and scope of the invention. For example, an advertiser may create composite templates. Accordingly, other embodiments are within the scope of the following claims.

What is claimed is:

1. A computer-implemented method for generating creatives comprising:
creating a first composite template;
defining one or more template elements for use with the first composite template;
assigning data to each of the one or more template elements; and
generating a first creative based on the first composite template and the assigned data, where the first creative comprises one or more creative elements corresponding to the one or more template elements.

2. The method of claim 1, further comprising:
creating an ad slot;
associating the ad slot with the first composite template; and
targeting the generated first creative to the ad slot.

3. The method of claim 2, further comprising:
creating a second composite template;
defining at least one template element for the second composite template;
assigning data to each of the at least one template element;
generating a second creative based on the second composite template and the assigned data of the at least one template element;
associating the ad slot with the second composite template; and
targeting the created second creative to the ad slot.

4. The method of claim 1, wherein assigning data comprises:
generating a form, wherein the form comprises fields corresponding to the one or more template elements;
presenting the form;
receiving input for each field, wherein the input comprises data corresponding to each of the one or more template elements; and
assigning data to each of the one or more template elements.

5. The method of claim 1, further comprising storing the first composite template.

6. The method of claim 1, further comprising storing the generated first creative.

7. The method of claim 1, wherein a first of the one or more template elements comprises one of the set consisting of a video, a text element, and an image.

8. The method of claim 2, wherein associating the ad slot with the first composite template comprises:
defining one or more attributes of the first composite template; and
associating the ad slot with the one or more attributes.

9. The method of claim 1, further comprising:
associating an interaction metric with a first of the one or more creative elements;
tracking events associated with the first creative element; and
updating the interaction metric based on the tracked events.

10. The method of claim 9, further comprising:
associating the interaction metric with a second of the one or more creative elements;
tracking events associated with the second creative element; and
updating the interaction metric based on the tracked events associated with the first creative element and the tracked events associated with the second creative element.

11. A computer-implemented method for serving creatives comprising:
receiving a request for a creative, wherein the request comprises an ad slot identifier;
identifying one or more creatives using the ad slot identifier;
determining a particular creative of the one or more creatives to return; and
returning the particular creative in response to the request.

12. The method of claim 11, wherein identifying the one or more creatives comprises:
determining one or more composite template identifiers associated with the ad slot identifier; and
identifying one or more creatives, wherein each of the one or more creatives comprises an attribute that matches at least one of the one or more composite template identifiers.

13. The method of claim 12, wherein each of the one or more composite template identifiers comprises one or more attributes associated with a composite template.

14. The method of claim 11, wherein returning the particular creative comprises:
rendering the particular creative in XML or custom HTML; and
returning the rendered creative in response to the request.

15. A system for generating creatives, comprising:
a processing device; and
a data store storing:
composite templates;
template elements;
creatives; and
program instructions that upon execution by the processing device cause the system to:
create a composite template;
define at least one template element to be included in the composite template;
assign data to each of the at least one template element; and
generate a creative based on the composite template and the assigned data, where the creative comprises at least one creative element corresponding to the at least one template element.

16. The system of claim 15, wherein the program instructions further cause the system to:
associate an ad slot with the composite template; and
target the generated creative to the ad slot.

17. The system of claim 15, wherein the program instructions further cause the system to:
define a set of attributes associated with the composite template;
associating an ad slot with the set of attributes; and
target the generated creative to the ad slot.

18. The system of claim 15, wherein the program instructions upon execution by the processing device further cause the system to:
associate an interaction metric with a first of the one or more creative elements;
track interaction events associated with the first creative element; and
update the interaction metric based on the interaction events.

19. A system for serving creatives, comprising:
a processing device; and
a data store storing:
composite templates;
template elements;
creatives; and
program instructions that upon execution by the processing device cause the system to:
receive a request for a creative, wherein the request comprises an ad slot identifier;
identify one or more stored creatives based on the ad slot identifier;
determine a particular creative of the one or more creatives to return; and
return the particular creative in response to the request.

20. The system of claim 19, wherein the program instructions that upon execution by the processing device cause the system to identify one or more creatives comprises instructions that upon execution by the processing device cause the system to:
determine a set of attributes associated with the ad slot identifier; and
identify the one or more creatives, wherein each of the one or more creatives comprises attributes that match the set of attributes associated with the ad slot identifier.

21. The system of claim 20, wherein the set of attributes comprises one or more types of composite templates, and wherein each of the one or more identified creatives was generated from at least one of the one or more types of composite templates.

22. A system for generating creatives, comprising:
means for creating a composite template;
means for defining one or more template elements for use with the composite template;
means for assigning data to each of the one or more template elements; and
means for generating a creative based on the composite template and the assigned data, where the creative comprises one or more creative elements corresponding to the one or more template elements.
